(19) United States
(12) Patent Application Publication
(10) Pub. No.: US 2025/0281944 A1
(43) Pub. Date: Sep. 11, 2025

(54) OBJECT DISTRIBUTION AND CONVEYING ARRANGEMENT AND SYSTEM

(71) Applicant: BOMILL AB, Vintrie (SE)

(72) Inventors: Per Horvath, Hörby (SE); Hansi Biedermann, Vintrie (SE)

(21) Appl. No.: 18/859,571

(22) PCT Filed: Apr. 20, 2023
(86) PCT No.: PCT/SE2023/050362

§ 371 Date: Oct. 24, 2024

(30) Foreign Application Priority Data
May 4, 2022 (SE) 2250546-5

(51) Int. Cl. B07C 5/36; B07C 5/342

(52) U.S. Cl. CPC B07C 5/363; B07C 5/3422

(57) ABSTRACT

Described is an object sorting system and an object distribution and conveying arrangement for distributing and conveying a plurality of objects. The object sorting system includes a plurality of sorting units. The plurality of sorting units includes a sorting system that includes an object measurement unit for conducting measurement associated with at least one property of an object of the plurality of objects and at least one ejector unit arranged to eject the object conveyed based on the at least one measured property of the object.

### TECHNICAL FIELD

The present invention concerns an object sorting system and an object distribution and conveying arrangement for distributing and conveying a plurality or a bulk of objects and a system comprising such an arrangement.

### BACKGROUND

It is known to sort objects within a bulk of objects, such as grains, by means of a rotating cylinder or drum, which cylinder has pockets on the inside. This cylinder is rotating around a substantially horizontal axis, while being aligned with its longitudinal central axis coinciding with said horizontal axis. The objects, such as granules, are fed into one end of the cylinder, and as the cylinder rotates, the granules will be lifted as they are captured in the pockets. The pockets are adapted in size and dimensions for receiving one object each. In the bottom of each pocket an opening is provided into the outside surface of the drum, such that for example light may be sent outside the drum, through the openings, onto the objects, and being detected on the inside of the drum or reflected to be detected on the outside of the drum, or vice versa. In this way, the object in the respective pocket may be illuminated with light, and reflection or transmission spectra may be obtained. From this spectra, characteristics of said objects may be obtained, which may be used to sort or fractionize said bulk of objects based on said characteristics. One or several collectors may then be placed in the vicinity of the drum, to receive-after characterization-a specified fraction based on impulses from the ejector via the detector system. A drum of this kind, and a machine comprising such drum, is disclosed in WO 2004/060585.

Another known sorting solution is to allow a bulk stream of objects to drop over a ledge, similarly to a waterfall. A camera or a set of cameras detect properties of the objects during the object's fall, and an ejector unit is arranged to eject objects having certain detected properties in the fall. In this way, the ejected objects are sorted out from the original bulk stream of objects. A downside of this solution is that it is rather imprecise, even with an optimized fluid jet stream, since for each ejection also several neighboring objects are ejected together with the object having the certain property. A majority of the ejected object may thus not have the certain property triggering the ejection, whereby the ejected group of objects has mixed properties. At the same time, many objects which should not have been ejected will be ejected by this method. This has a detrimental impact on the throughput of the system as well as the capability and degree of precisely sorting out objects having different properties, since for example only one fraction may be separated. Further, such a system requires a lot of space due to the camera equipment being bulky and requiring complex control systems. The size of the camera equipment results in the system having to implement a waterfall design where all of the objects are conveyed in the same plane with the camera equipment extending across the entire conveying area. Further, the camera equipment, which may includes one camera for each channel or section of the conveying area, needs to be placed a relatively long distance away from the objects in order for the wide angle lens to properly identify the property forming the basis of the sorting to thereby capture the entire width of the stream of material. In addition, the objects need to be monitored by cameras from two sides for proper identification of the property. Thus, a drawback of a camera based sorting system is that it requires large volumes of space in order to achieve a desirable result.

In order to address this, a system presented in WO 2019/054932 has been developed. In the disclosed system a plate with channels is used for conveying and separating the fractions of the objects, whereby the objects are sorted based on timing and velocity measurements together with optical readings. However, such a system is limited in terms of capacity.

The present inventors have realized that there is room for improvement within this field.

### SUMMARY

Accordingly, the present invention preferably seeks to mitigate, alleviate or eliminate one or more of the above-identified deficiencies in the art and disadvantages singly or in any combination and solves at least the above mentioned problems by providing an object sorting system.

The object sorting system comprises a plurality of sorting units. The plurality of sorting units comprises a guide plate. The guide plate has at least one channel extending in a sorting pane inclined relative a horizontal reference plane for conveying the objects from a first longitudinal position to a second longitudinal position downstream to the first longitudinal position. The first longitudinal position is elevated relative the second longitudinal position.

The plurality of sorting units further comprises a sorting inlet for conveying the objects into the sorting unit to the first longitudinal position and a sorting outlet for conveying the objects out of the sorting unit from the second longitudinal position.

The plurality of sorting units further comprises a sorting system comprising an object measurement unit for conducting measurements associated with at least one property of an object of the objects and at least one ejector unit arranged to eject the object conveyed based on the at least one measured property of the object at a longitudinal position of the channel between the first and second longitudinal position.

At least one sorting unit of the plurality of sorting units is arranged above at least one other sorting unit of the plurality of sorting units relative a vertical reference direction.

According to one aspect, an object distribution and conveying arrangement for distributing and conveying a plurality of objects is provided. The arrangement comprises an object sorting system according to the above. Said arrangement further comprises an outlet manifold for receiving and conveying sorted objects from at least two sorting units and/or an inlet manifold for receiving and conveying the objects to at least two sorting units for sorting of the objects.

According to one aspect, an object distribution and conveying arrangement for distributing and conveying a plurality of objects is provided.

The arrangement comprises an outlet manifold for receiving and conveying sorted objects from at least two sorting units. The outlet manifold comprises a plurality of inlets for conveying the sorted objects out of the sorting units. The outlet manifold comprises at least two separate outlet passages.

Each of the at least two separate outlet passages is joined with at least two inlets of the plurality of inlets. Each of the at least two inlets is arranged to convey sorted objects from a respective sorting unit of the at least two sorting units into said separate outlet passage.

According to one aspect, an object distribution and conveying system is provided. The system comprises an arrangement according to the above and a plurality of sorting units. Each sorting unit is configured to sort a portion of the objects. The inlet manifold is connected to the sorting units for conveying and distributing the objects to said sorting units.

According to one aspect, an object distribution and conveying arrangement for distributing and conveying a plurality of objects is provided. The arrangement comprises an inlet manifold for receiving and conveying the objects to sorting units for sorting of the objects.

The inlet manifold comprises one or more feeder inlet for feeding the objects into the inlet manifold, at least two outlets for distributing the objects to the sorting units.

The inlet manifold further comprises a guiding arrangement. The guiding arrangement connects the one or more feeder inlet and the at least two outlets. The guiding arrangement is adapted to convey the objects downwardly and diagonally relative a horizontal reference plane from the one or more feeder inlet downstream to the at least two outlets.

According to one aspect an object distribution and conveying system comprising an arrangement according to the above is provided. The system further comprises a plurality of sorting units, each sorting unit being configured to sort a portion of the objects. The inlet manifold is connected to the sorting units for conveying and distributing the objects to said sorting units.

Advantageous embodiments are envisioned in the dependent claims below.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a perspective view an object distribution and conveying system according to an embodiment of the present invention;

FIG. 2 is a perspective view of an object distribution and conveying arrangement according to an embodiment of the invention;

FIG. 3 is a partial cross-section view of aspects of an object distribution and conveying arrangement according to an embodiment of the present invention;

FIG. 4 is a perspective view of aspects of an object distribution and conveying arrangement according to an embodiment of the present invention;

FIG. 5 is a schematic depiction of aspects of sorting units and an inlet and outlet manifold according to an embodiment of the invention;

FIG. 6 is a schematic depiction of aspects of sorting units and an inlet and outlet manifold according to an embodiment of the invention;

FIG. 7 is a schematic top view of a sorting unit according to an embodiment of the invention;

FIG. 8 is a perspective view of aspects of a sorting unit according to an embodiment of the invention;

FIG. 9 is a perspective view of aspects of a sorting unit according to an embodiment of the invention; and

FIG. 10 is a perspective view of aspects of a sorting unit according to an embodiment of the invention

### DETAILED DESCRIPTION

The following description is dedicated to an object distribution and conveying arrangement for forming a part of a system used to sort out objects having certain measured properties from a bulk of objects. Such objects may be organic or inorganic, such as e.g. grains, granules, lentils, nuts, tree nuts, beans, recyclables, minerals, metals, plastics, etc.

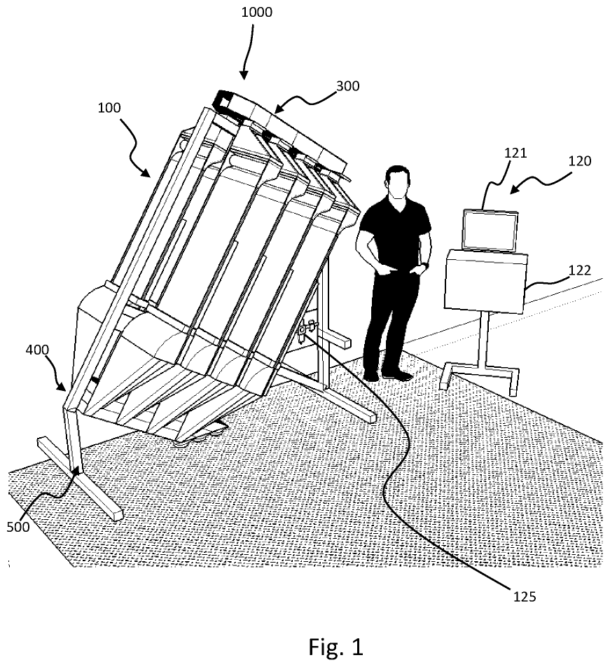

FIG. 1 schematically depicts an object distribution and conveying system according to an embodiment.

The object distribution and conveying system comprises a distribution and conveying arrangement 1000 for distributing and conveying a plurality of objects as described above.

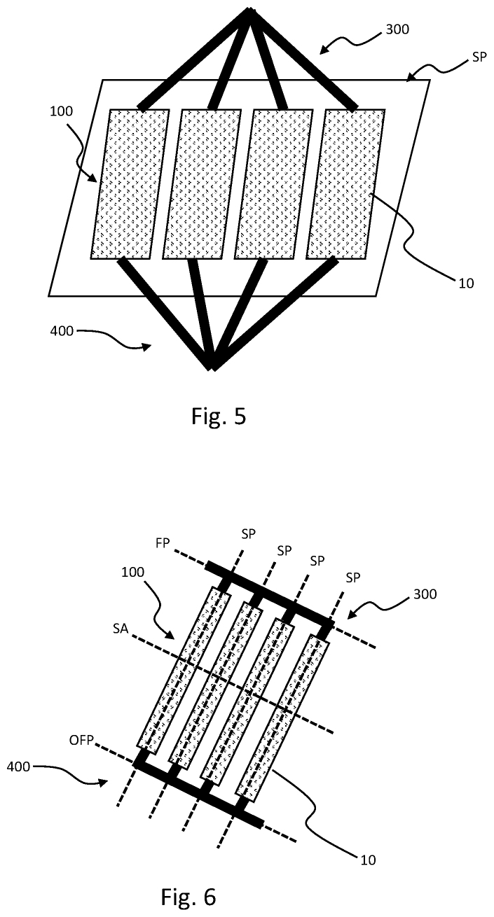

The arrangement 1000 comprises an inlet manifold 300 for receiving and conveying the objects to sorting units 100 for sorting of the objects. The object distribution and conveying system may thus comprise a plurality of sorting units 100. Each sorting unit 100 may be configured to sort a portion of the objects, e.g. the objects which are conveyed into the sorting units 100, by means of the inlet manifold 300. As will be described with reference to FIGS. 6 to 10, the sorting units 100 may be adapted to sort the plurality of objects into a fraction based on at least one property associated with said objects.

The inlet manifold 300 may be connected to the sorting units 100 for conveying and distributing the objects to the sorting units 100. The sorting units may form an object sorting system.

In one embodiment, the arrangement 1000 may comprise more than one inlet manifold 300. The arrangement 1000 may thus comprise one or more inlet manifold 300 as described above. Hence, a plurality of inlet manifolds, each comprising a guiding arrangement and outlets for conveying objects to the sorting units, may be comprised in the arrangement 1000. In one embodiment, a first inlet manifold may be arranged above a second inlet manifold relative a vertical reference direction. In one embodiment, a plurality of inlet manifolds may be arranged on top of each other relative a vertical reference direction. In one embodiment, a plurality of inlet manifolds may be arranged directly on top of each other relative a vertical reference direction.

The sorting units 100 may comprise ejector units, which are pneumatically operated. The sorting units may thus be operated by means of air supplied from a pneumatic system 125. The ejector units are thus connected to said pneumatic system 125 and provided with pressurized air from said pneumatic system 125. The pneumatic system may be operatively connected to a control system 120. The control system may comprise a control unit 122 and a controller interface 121 configured to receive input from a user for the control of the sorting units 100. The control system 120 may be configured to control the pneumatic system 125. The ejector units may be provided with valves controlled by means of the control system 120 to provide the discharge of air through said ejector units.

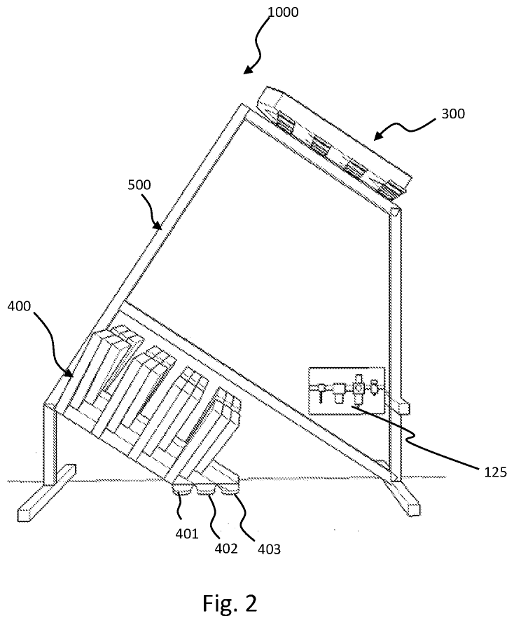

FIG. 2 depicts the object distribution and conveying arrangement 1000 in further detail.

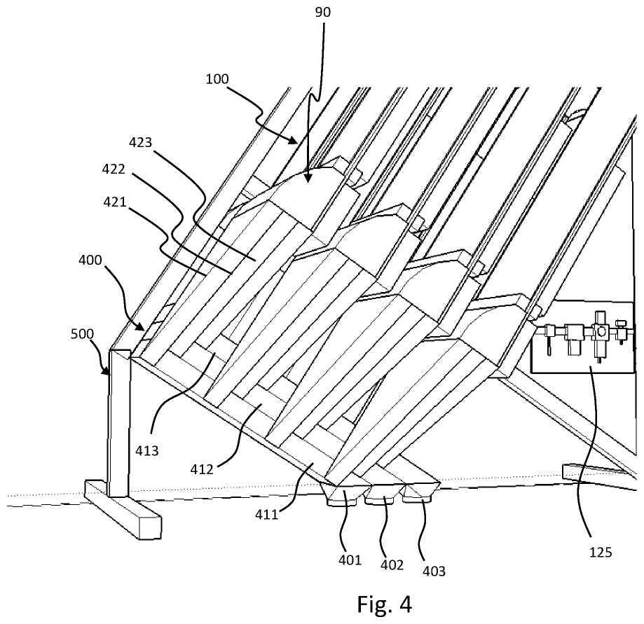

In the depicted embodiment, the arrangement 1000 comprises an outlet manifold 400 for conveying the objects out of the sorting units. It may be envisioned however, that the objects are conveyed directly from the sorting units to separate vessels, pipes or containers not forming part of the arrangement 1000. However, as will be elaborated further with reference to FIG. 4, the outlet manifold 400 according to the present invention allows for a more compact and clean manner of gathering the sorted objects. It may also be envisioned that the inlet manifold is in the form of separate channels extending to each sorting unit. Such an inlet manifold may also be combined with an outlet manifold according to the invention.

In the depicted embodiment, the arrangement 1000 further comprises a support structure 500. The support structure 500 is adapted to carry and support the sorting units. Hence, the support structure 500 is adapted to retain the sorting units. Preferably, the support structure 500 is adapted to releasably retain the sorting units to enable easy access for service and adaption of the number and placement of the sorting units. As a result, a modular system in which sorting units may be removed and added is achieved. The conveying and distribution system may thus be considered a modular conveying and distribution system.

In one embodiment, the support structure 500 is a floor-standing support structure. In one embodiment, the support structure 500 is a stand-alone support structure. Thus, the support structure 500 may be provided with legs for standing on a floor.

Further referencing FIG. 2, the inlet manifold 300 and/or the outlet manifold 400 may be mounted to the support structure 500, whereby the support structure 500 is adapted to carry and support said inlet manifold 300 and/or outlet manifold 400. Preferably said inlet manifold 300 and/or outlet manifold 400 is releasably mounted to the support structure 500. This allow for an arrangement which is easier to service and inspect for service personnel.

In one embodiment, the support structure 500 is adapted to carry the pneumatic system 125. The pneumatic system 125 may thus be mounted to said support structure 500.

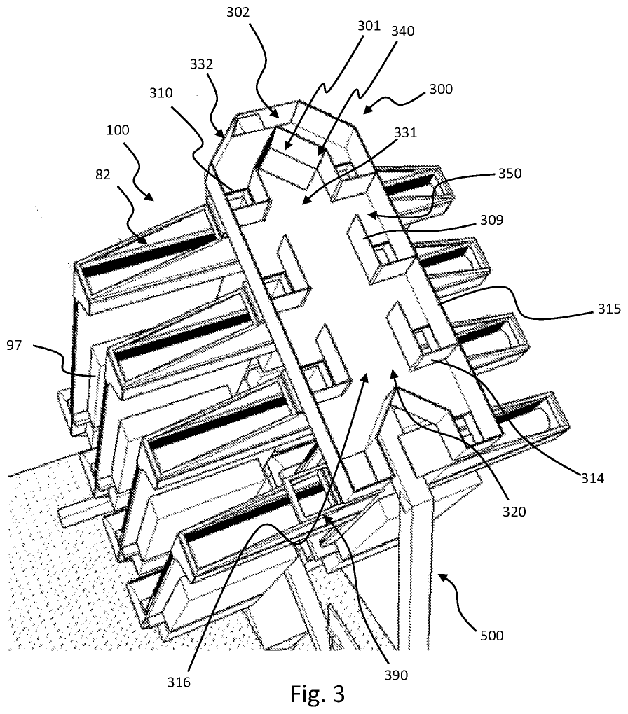

FIG. 3 depicts the inlet manifold 300 in further detail. In FIG. 3 a housing 340 of the inlet manifold is made transparent for showing the interior of the inlet manifold 300.

The inlet manifold 300 comprises one or more feeder inlet 301, 302 for feeding the objects into the inlet manifold 300. Hence, the one or more feeder inlet 301, 302 is arranged to receive a plurality of objects and allowing access for said objects into the inlet manifold 300. Worded differently, the one or more feeder inlet 301, 302 is adapted to convey the objects into the inlet manifold 300.

In the depicted embodiment, the inlet manifold comprises a first feeder inlet 301 and a second feeder inlet 302. Having a plurality of feeder inlets may allow for distribution of different types of objects simultaneously as well as an increased capacity of the inlet manifold.

In one embodiment, the first and second feeder inlet may be adapted to receive objects within different size intervals or of different types, whereby a more versatile arrangement capable of receiving different types of objects without requiring components to be exchanged is achieved. Different types of objects may for example refer to different types of grains. Such adaptions to objects within different size intervals or of different types may include but not be limited to the geometry, depth, size and dimensions of the first and second feeder inlet.

The inlet manifold 300 further comprises at least two outlets 310 for distributing the objects to the sorting units 100. As depicted, each outlet of said at least two outlets 310 may be intended to distribute the objects to a separate sorting unit 100. It may be envisioned however that one outlet is connected to one or more sorting unit or that multiple outlets may be connected to one sorting unit.

The inlet manifold 300 further comprises a guiding arrangement 350. The guiding arrangement 350 connects the one or more feeder inlet 301, 302 and the at least two outlets 310. Hence, the guiding arrangement 350 is arranged to convey the objects between the one or more feeder inlet 301, 302 and the at least two outlets 310. The guiding arrangement may be further adapted to distribute the objects into portions between the at least two outlets 310.

The guiding arrangement 350 is adapted to convey the objects downwardly and diagonally relative a horizontal reference plane from the one or more feeder inlet 301, 302 downstream to the at least two outlets 310.

Such an inlet manifold allows for a compact system for sorting which still is able to sort a relatively large number of objects due to the distribution of objects between the sorting units being conducted in the inlet manifold. Further, the use of such an inlet manifold allows the transportation of the objects to be conducted in the same unit, which is preferable both in terms of complexity and compactness.

The guiding arrangement 350 is adapted to convey the objects downwardly and diagonally relative a horizontal reference plane allowing the potential energy of the objects to convey the objects along the guiding arrangement 350.

Preferably, the guiding arrangement 350 is arranged to convey the objects in angle, e.g. a sloping angle, relative a horizontal reference plane. The angle is larger than an angle of repose of the objects such that the objects are at least partially conveyed by means of gravity. In one embodiment, the objects are conveyed solely by means of gravity, e.g. solely conveyed by means of the potential energy of the objects.

It may be envisaged however that other means of conveying are utilized in combination with the diagonal guiding provided by the guiding arrangement. In one embodiment, the inlet manifold may be provided with an oscillating drive system mounted to the guiding arrangement or the inlet manifold. The oscillating drive system may be configured to transfer a shaking movement to the guiding arrangement. The provision of an oscillating drive system allows the guiding arrangement to convey the objects at a smaller sloping angle compared to a guiding arrangement solely conveying the objects by means of gravity.

It is generally noted with reference to the above and further references herein to an angle of repose that although the objects intended to be conveyed in the arrangement 1000 and system may have differing of angles of repose, parts of the system may be arranged to convey the objects in an angle outside the interval of plausible angles of repose for the objects to allow for gravity to convey the objects. An angle of repose is herein generally referenced as an angle between a horizontal reference plane and an upwardly facing diagonal direction and/or upwardly and diagonally extending plane. Hence an angle larger than said angle of repose corresponds to a steeper downwardly facing direction along which the objects are conveyed compared to a downwardly facing direction corresponding to the angle of repose. Said angle being larger than the angle of repose may be considered a downward angle relative a horizontal component of the movement direction of the objects.

The guiding arrangement 350 may form a plurality of passages for conveying and distributing the object to the at least two outlets 310. The plurality of passages may either be formed as separate passages only extending between the feeder inlet and an outlet, or an open compartment provided with dividing elements for guiding the objects to different desired locations, e.g. outlets, or a combination thereof.

Referencing FIG. 3, the first feeder inlet 301 is connected to one or more passage of the plurality of passages. The second feeder inlet 302 is correspondingly connected to one or more passage of the plurality of passages. For example, the first feeder inlet 301 is connected to a first passage 331. The first passage 331 is in turn connected to two outlets 310, whereby each outlet is adapted to be connected to or connected to a sorting unit 100. The second feeder inlet 302 is connected to a second passage 332 with guiding elements for guiding portions of the objects to a plurality of outlets 310 connected to the open passage 332. The passages may be formed by means of flow separating wall sections 309. Each of the outlets 310 is adapted to be connected to or connected to a sorting unit 100. In the depicted second passage 332, flow separating wall sections are provided at every outlet 310 for guiding a portion of the objects into said outlet 310. The flow separating wall sections 309 extends substantially along the downstream direction of the objects, i.e. in the conveying direction of the guiding arrangement 350. Flow separating wall sections 309 may be arranged proximal to the outlets 310 for guiding a fraction or portion of the objects into said outlets 310.

The guiding arrangement 350 may further comprise diverter wall sections 314. The diverter wall sections 314 may extend substantially orthogonal to the downstream direction of the objects. A diverter wall section 314 may be arranged downstream each outlet 310 to prevent objects passing over said outlet 310. In the depicted example, the diverter wall sections 314 are connected to a corresponding flow separating wall section 309. The diverter wall section 314, the flow separating wall section 309 and a circumferential wall 315 of the guiding arrangement together partially extend around the outlets 310 thereby only enabling access for the objects to the outlet 310 in a downstream direction.

In one embodiment, at least some or preferably all of the diverter wall sections may be pivotable about an axis substantially perpendicular to the flow direction of the objects in the inlet manifold. Said axis may extend as a normal to a feeding plane which will be described in further detail later on. The diverter wall sections may be pivotable about their axis such that the diverter wall sections selectively is arranged to cooperate with different flow separating wall sections, thereby controlling the extension of a passage of the guiding arrangement. For example, the diverter wall sections may be pivotable between a first and second position. In the first position, the diverter wall section 314 may be arranged downstream an outlet 310 to prevent objects passing across said outlet 310. In the second position, the diverter wall section 314 may be arranged to extend along the flow direction of the objects and guide the objects across said outlet 310 to another outlet 310 arranged downstream of said outlet 310.

To enable easier conveying into the inlet manifold, the first feeder inlet 301 and the second feeder inlet 302 may both be provided adjacent to each other at a feeding section of the inlet manifold 300. Hence, at least two passages of the plurality of passages extends diagonally and downwardly towards at least one of the outlets 310 from a position proximal to said feeding section.

To achieve a more space-efficient and less complex inlet manifold, the guiding arrangement 350 may comprise a guiding plate member 320. The guiding plate member 320 is arranged to convey the objects. The guiding plate member 320 may be adapted to convey the objects downwardly and diagonally relative a horizontal reference plane. The outlets 310 may be provided as through-going apertures in the guiding plate member 320.

As will be further described with reference to FIGS. 5-6, the guiding arrangement 350 may be arranged to convey the objects along a feeding plane. The feeding plane is inclined relative a reference horizontal plane. The guiding arrangement conveying the objects along the same feeding plane, for example via the guiding plate member 320, allows for gravity (and potential energy) to convey the objects in a more space-efficient manner compared to having individual sloping tubes or channels.

Accordingly, the guiding plate member 320 may be arranged to convey the objects along said feeding plane. The guiding plate member 320 may extend along said feeding plane.

The plurality of passages may be formed by flow separating wall sections 309 provided on the guiding plate member 320. Thus, a less complex inlet manifold is achieved.

Further, guiding plate member 320 may be provided with the circumferential wall 315. The circumferential wall 315 may be provided on the guiding plate member 320. The circumferential wall 315 is adapted to enclose the guiding plate member 320. The diverter wall sections 314 may be connected to and preferably pivotably connected to said circumferential wall 315. However, in an advantageous embodiment, the diverter wall sections 314 may be connected to and preferably pivotably connected to flow separating wall sections 309.

To exemplify the function of the inlet manifold 300, a plurality of objects may be fed into the inlet manifold via the one or more feeder inlet 301, 302. The flow of the objects is then divided by being led via different passages along the guiding arrangement, e.g. guiding plate member 320. This may be achieved by means of flow separating wall sections. The separated portions of the flow of objects are then led to outlets 310 connected to the guiding arrangement and thereafter into sorting units 100 for subsequent sorting.

In the depicted embodiment, the guiding arrangement 350 comprises a first and second sealed-off section or passage connected to the first and second feeder inlet 301, 302 respectively.

The first section or passage is connected to the first feeder inlet 301 and is delimited by a portion of the circumferential wall 315 and flow dividing wall sections 309. A first portion of the first section or passage comprises a plurality of flow dividing wall sections 309 which may extend parallel to the downstream direction. An open pathway along the downstream direction is provided between pairs of flow dividing wall sections 309 each adapted to guide a fraction of the objects into a corresponding outlet 310. A diverter wall section 314 is arranged at each of the outlets 310. A second portion of the first section or passage is disposed downstream of the first portion. At the second portion, a portion of the circumferential wall 315 may form an angle relative the downstream direction delimiting the open pathway such that a flow of objects conveyed through the open pathway is divided among at least a first and second outlet 310 of said second portion. The first and second outlet of the second portion are arranged on opposite lateral sides of the open pathway. The first feeder inlet 301 may be arranged at a center axis of the guiding plate member 320 extending along the downstream direction. The open pathway may thus extend along said center axis.

The second section or passage is connected to the second feeder inlet 302 and is delimited by a portion of the circumferential wall 315, a set of diverter wall sections 314 and flow dividing wall sections 309. The flow dividing wall sections 315 forms an angle relative the downstream direction such that a flow of objects from the second feeder inlet 302 is divided amongst at least a first and second outlet arranged downstream of the second feeder inlet. The first and second outlet of the second section are arranged on different lateral sides of the center axis. The second feeder inlet 302 may be arranged at the center axis of the guiding plate member 320 extending along the downstream direction.

In the depicted embodiment, the diverter wall sections 314 may be movable so as to selectively allow access for the objects conveyed in the first or second section or passage to their associated outlet 310. Hence, the diverter wall sections 310 may be movable to alter the extension of the first and second section or passage to thereby selectively include outlets 310 in said first and second section or passage or exclude outlets 310 from said first and second section or passage.

To allow for service and check-up, the inlet manifold 300 may be adapted to be releasably connected to the sorting units 100. The outlet manifold 400 and the sorting units 100 may be releasably connected by means of a releasable pipe connection. To allow for a sealed system, the releasable pipe connection may comprise a gasket. In one embodiment, the inlet manifold 300 and the sorting units may be releasably interconnected by means of the support structure. Thus, the support structure may comprise connecting members, whereby the inlet manifold 300, i.e. the outlets of the inlet manifold 300, and the sorting units, i.e. the inlets of the sorting units, are releasably connected to the connecting members. The connecting members thus provide passage for the objects from the outlets of the inlet manifold to the inlets of the sorting units.

As aforementioned, the inlet manifold 300 may comprise a housing 340. The housing 340 is arranged to house the guiding plate member 320. The housing 340 is thus arranged to cover the guiding plate member 320. The housing 340 may be provided with one or more through hole. Said one or more through hole provides external access to the guiding plate member 320 thereby forming the one or more feeder inlet 301, 302.

In one embodiment, the arrangement 1000 may further comprise gate units 390. In the depicted example, only one gate unit is shown. The gate units 390 may be provided at the inlet manifold 300. Each gate unit 390 may be arranged in conjunction with the inlet manifold 300. Each gate unit 390 is adapted to selectively enable conveying and distribution of the objects to a sorting unit 100. Thereby, the distribution of objects into the sorting units may be adapted in accordance with the number and type of object to be sorted and conveyed. For example, in the case of a large number of objects to be sorted, the gate unit 390 may be opened in order to allow each of the sorting units to receive fractions of the total amount of objects. At some instances, only a relatively small number of objects is to be sorted, in such cases it may be disadvantageous to utilize all of the sorting units. Thus, one or more gate unit 390 may be closed during operation to allow for removal of a sorting unit without disrupting the sorting process. This may be particularly advantageous in the case of a sorting unit not working properly or requiring service.

The gate units 390 may be arranged to selectively block the outlet 310. It is however noted that the gate units 390 may be positioned anywhere along the passages or relative the inlets while still providing the same function.

In the depicted embodiment, the gate units 390 are slidable gate units 390 slidable between a first position and a second position. In the first position, the objects are allowed access into the sorting unit through the outlet 310. In the second position, the gate unit 390 blocks access through the outlet 310 for the objects. The slidable gate unit(s) may be manually and/or automatically operable. The slidable gate unit(s) may be slidably connected to the inlet manifold or a sorting unit of the plurality of sorting units.

FIG. 4 depicts the outlet manifold 400 in further detail.

The outlet manifold 400 comprises a plurality of inlets 421, 422, 423 for conveying the objects out of the sorting units 100. The plurality of inlets 421, 422, 423 is thus adapted to be connected to said sorting units 100. The plurality of inlets 421, 422, 423 and the outlet manifold 400 as a whole are arranged downstream to the sorting units 100 as well as the inlet manifold 300.

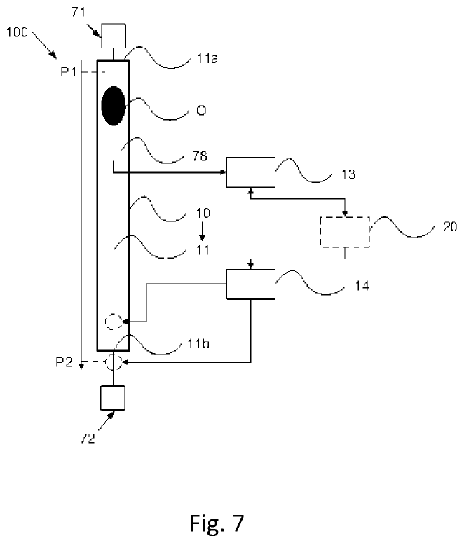

To allow for service and check-up, the outlet manifold 400 may be adapted to be releasably connected to the sorting units 100. The outlet manifold 400 and the sorting units 100 may be releasably connected by means of a releasable pipe connection. To allow for a sealed system, the releasable pipe connection may comprise a gasket. In one embodiment, the outlet manifold 400 and the sorting units may be releasably interconnected by means of the support structure. Thus, the support structure may comprise connecting members, whereby the outlet manifold 400, i.e. the inlets of the outlet manifold 400, and the sorting units, i.e. the outlets (including the collector channels which will be described in further detail with reference to FIG. 7) of the sorting units, are releasably connected to the connecting members. The connecting members thus provide passage for the objects from the outlets of the sorting units to the inlets of the outlet manifold.

In the depicted embodiment, a plurality of inlets 421, 422, 423 is adapted to be connected to a single sorting unit 100. Thereby the outlet manifold may collect a plurality of sorting fractions sorted out in said sorting unit 100. Preferably, a plurality of inlets 421, 422, 423 of the outlet manifold 400 is connected to each sorting unit 100. The outlet manifold 400 is intended to receive and convey sorted objects O from at least two sorting units 100.

Advantageously, at least two inlets 421, 422, 423 of the plurality of inlets are adapted to be connected to each one of the sorting units 100 for conveying the objects out of the sorting unit 100 after sorting in said sorting unit 100. A plurality of said inlets may extend parallel to each other.

The outlet manifold 400 may form one or more separate outlet passage 411, 412, 413. Each outlet passage 411, 412, 413 may be connected to a distribution outlet 401, 402, 403 for conveying the objects out of the object distribution and conveying arrangement 1000. For example, the distribution outlets may be connectable to separate containers for packaging of the objects or separate machines for treating of the objects etc.

The separate outlet passage 411, 412, 413 may be considered an individual, discrete or independent outlet passage. Thus, each outlet passage may be separate from the remaining outlet passages. A plurality of said outlet passages may extend parallel to each other.

As depicted in FIG. 4, the inlets 421, 422, 423 connected to a first sorting unit 100 may each be connected to a corresponding separate outlet passage 411, 412, 413. Further, the inlets 421, 422, 423 connected to a second sorting unit 100 may be connected to the same outlet passages 411, 412, 413, whereby corresponding inlets connected to the first and second sorting unit may be joined by means of the same separate outlet passage. Hence, a fraction of objects conveyed via an inlet 421, 422, 423 connected to a first sorting unit 100 may be conveyed out of the outlet manifold 400 through the same separate outlet passage 411, 412, 413 as a corresponding fraction of objects conveyed via a corresponding inlet 421, 422, 423 connected to a second sorting unit.

Thus, a first inlet 421 of the outlet manifold 400 connected to a first sorting unit 100 may be connected to a first separate outlet passage 411 and a second inlet connected to said first sorting unit 100 may be connected to a second separate outlet passage 412. Correspondingly, a first inlet 421 of the outlet manifold 400 connected to a second sorting unit 100 may be connected to said, i.e. the same, first separate outlet passage 411 and a second inlet 422 connected to said second sorting unit may be connected to said, i.e. the same, second outlet passage 412. This type of connection may be utilized for any number of inlets connected to a single sorting unit, any number of sorting units and corresponding separate outlet passages.

Accordingly, the outlet manifold 400 comprises a plurality of inlets 421, 422, 423 for conveying the sorted objects out of the sorting unit. The outlet manifold 400 further comprises at least two separate outlet passages 411, 412, 413. Each of the at least two separate outlet passages 411, 412, 413 is joined with at least two inlets of the plurality of inlets 421, 422, 423. Each of said at least two inlets is arranged to convey sorted objects from a respective sorting unit 100 of the at least two sorting units 100 into said separate outlet passage. Hence, a first inlet of the at least two inlets may be adapted to be connected to a first sorting unit, a second inlet of the at least two inlets may be adapted to be connected to a second sorting unit and so on.

The joined channels allows for a compact outlet arrangement for the system, thus allowing for a more space-efficient system.

Worded differently, the outlet manifold 400 comprises a plurality of inlets 421, 422, 423 for conveying the sorted objects O from at least two sorting units 100. A first inlet 421 and a second inlet 422 are arranged to convey sorted objects O from each sorting unit 100. The outlet manifold 400 comprises at least two separate outlet passages 411, 412, 413, whereby the first inlets 421 joins with a first separate outlet passage and the second inlets 422 joins with a second separate outlet passage. Each separate outlet passage 411, 412, 413 is connected to a distribution outlet 401, 402, 403 for conveying the objects out of the object distribution and conveying arrangement.

As depicted in FIG. 4, a plurality of first inlets, each connected to a separate sorting unit 100, may be joined with a first separate outlet passage 411 for conveying a first fraction of sorted objects from said sorting units 100. Similarly, a plurality of second inlets, each connected to a separate sorting unit 100, may be joined with a second separate outlet passage 412 for conveying a second fraction of sorted objects from said sorting units 100.

FIGS. 5 and 6 schematically depicts how the inlet manifold and the outlet manifold may be arranged relative the sorting units. In the depicted embodiments, the sorting units 100 are arranged next to each other relative a horizontal direction or stacked on top of each other along a particular direction.

The inlet manifold 300 is arranged at an elevated position relative the outlet manifold 400 such that the objects are conveyed downwardly from the inlet manifold 300 to the outlet manifold 400. The inlet manifold 300 and the outlet manifold 400 are connectable via the sorting units 100. Hence, the objects are conveyed from the inlet manifold 300 via the sorting units to the outlet manifold 400.

As aforementioned, the guiding arrangement may be arranged to convey the objects along the feeding plane FP.

The outlet manifold 400 may be arranged to convey the objects at least partly by means of gravity and preferably entirely by means of gravity. Hence, the outlet manifold 400 may be adapted to convey the objects downwardly and diagonally relative a horizontal reference plane from the plurality of inlets 421, 422, 423 downstream through the at least two separate outlet passages 411, 412, 413. Thus, the one or more separate outlet passages may be arranged to convey the objects downwardly and diagonally downstream towards the distribution outlets. This may be achieved by means of the potential energy of the objects. The one or more separate outlet passages and preferably the plurality of separate outlet passages 411, 412, 413 may each extend along an outlet feeding plane OFP.

It may however be envisioned that other means of conveying are utilized in combination with the diagonal guiding provided by the outlet manifold. In one embodiment, the outlet manifold may be provided with an oscillating drive system configured to shake the outlet manifold. The provision of an oscillating drive system allows the outlet manifold to convey the objects at a smaller sloping angle compared to an outlet manifold solely conveying the objects by means of gravity.

The outlet feeding planes OFP may each be arranged substantially parallel to the feeding plane FP. The plurality of inlets of the outlet manifold 400 may form inlet channels. The inlet channels of the outlet manifold may be adapted to convey the objects downwardly and diagonally relative a horizontal reference plane. As for the feeding plane, the outlet passages and the inlets of the outlet manifold may be arranged at angles relative a horizontal reference plane larger than an angle of repose of the objects such that the objects are at least partially conveyed by means of gravity in said outlet passages and inlets of the outlet manifold. In one embodiment, the inlet channels of the of the outlet manifold are arranged to extend substantially orthogonally to the outlet passages. In one embodiment, the inlet channels may extend substantially orthogonally to the outlet feeding planes OFP.

As depicted in FIGS. 5 and 6, each sorting unit 100 may comprise a guide plate 10. Each guide plate has at least one channel, which extends in a sorting plane SP. The channel is inclined relative a horizontal reference plane for conveying the objects. The channel may be inclined such as to allow for the potential energy of the objects to convey said objects along the channel. Similar to the outlet and inlet manifold, it may be envisioned that an oscillating drive or other means of conveying the objects may be utilized as a complement or alternative to the potential energy of the objects for conveying said objects.

To enable gravity to properly convey the objects throughout the inlet manifold and the sorting units, angles formed between the feeding plane FP and each of the sorting planes SP may be between 60 and 120 degrees. Preferably said angles may be around 90 degrees.

Referencing FIG. 5, at least one sorting unit 100 of the plurality of sorting units is arranged above at least one other sorting unit 100 of the plurality of sorting units relative a vertical reference direction. This type of stacked object sorting system does not require much room and is enabled by the object measurement and ejection system that will be described in further detail with reference to FIG. 7. As eluded to earlier, a conventional camera-based sorting system would require too much space between each sorting unit to make such a stacked object sorting system viable.

In one embodiment, the at least two sorting units are arranged directly on top of each other relative a vertical reference direction. In one embodiment, two or more sorting units are stacked on top of each other relative said vertical reference direction. The two or more sorting units may be stacked on top of each other with a distance between each pair of adjacent sorting units.

In one embodiment, the angle between each of the sorting planes SP and the vertical reference direction is between 30 and 60 degrees. Hence, the angle between a downstream direction of the objects in the sorting plane SP and a downwardly directed vertical reference direction may be between 30 and 60 degrees. Accordingly, the angle between a downwardly facing normal direction from the sorting planes SP and the vertical reference direction may be between 30 and 60 degrees.

In one embodiment, at least two sorting units 100 may have channels extending in coinciding sorting planes SP. Referencing FIG. 6, at least two sorting units 100 may have channels extending in substantially parallel sorting planes SP.

Preferably, the sorting units may be arranged in a matrix configuration with more than one sorting unit 100 having coinciding sorting planes and more than one sorting unit having substantially parallel sorting planes SP. Thus, an arbitrary number of sorting units 100 may be arranged along a first direction with channels having parallel sorting planes SP and an arbitrary number of sorting units 100 may be arranged along a second direction with channels having coinciding sorting planes SP. The coinciding and/or parallel sorting planes SP allows for a very compact object distribution and conveying system.

Further referencing FIG. 6, to enable both conveying of the objects by means of gravity and a compact system, at least two sorting units 100 may be distributed in a stacked configuration. Alternatively or additionally, sorting planes in which the one or more channel of at least two sorting units 100 extends may be distributed in a stacked configuration. Said sorting units 100 and/or sorting planes SP may be arranged or distributed in a stacked configuration along a stacking axis SA. Preferably, said sorting units 100 and/or sorting planes SP may be substantially evenly distributed along said stacking axis SA.

In order to further increase the compactness of the system, the stacking axis SA may be arranged substantially parallel to the feeding plane FP and/or the outlet feeding plane(s) OFP.

Advantageously, the sorting plane SP is arranged to extend in an angle relative a horizontal reference plane larger than an angle of repose of the objects such that the objects are at least partially conveyed by means of gravity.

Thus, the outlet manifold 400, the sorting units 100 and the inlet manifold 300 may together convey the objects along a Z-pathway downstream and downwards through the system. The Z-pathway enables greater utilization of the potential energy in relation to the height of the system.

The sorting units 100 will now be described in further detail with reference to FIGS. 7-10.

A top view of a sorting unit is shown in FIG. 7.

The sorting units 100 comprises a guide plate 10. The guide plate 10 has at least one channel 11. The at least one channel 11 extends in a sorting plane inclined relative a horizontal reference plane for conveying the objects O from a first longitudinal position P1 to a second longitudinal position P2. The second longitudinal position P2 is downstream to the first longitudinal position P1. The first longitudinal position P1 is elevated relative the second longitudinal position P2.

The sorting unit 100 further comprises a sorting inlet 71. The sorting inlet 71 is connected to one of the at least two outlets 310 of the inlet manifold 300 for conveying the objects O to the first longitudinal position P1.

The sorting unit 100 further comprises a sorting outlet 72 conveying the objects O out of the sorting unit 100 from the second longitudinal position P2. The sorting outlet 72 may be provided at the second longitudinal position P2 for conveying the objects O out of the sorting unit 100.

Each sorting unit further comprises a sorting system, i.e. an individual sorting system configured to sort the objects conveyed through said sorting unit. The sorting system may be configured to sort the objects into two or more fractions. The fractions may be based on at least one measured property of the objects.

The sorting system comprises an object measurement unit 13 for conducting measurement associated with at least one property of an object O of the objects. The sorting system further comprises at least one ejector unit 14 arranged to eject the object O based on the at least one measured property of the object at a longitudinal position of the channel between the first longitudinal position P1 and the second longitudinal position P2.

The sorting system may further comprise a sorting system control unit 20. The sorting system control unit 20 may be operatively connected to the at least one ejector unit 14 and the object measurement unit 13. The sorting system control unit 20 may be configured to control said ejector unit 14 and said object measurement unit 13.

In one embodiment, the guide plate 10 has at least one channel 11 for conveying the object O between a first end 11a and a second end 11b of the corresponding channel 11.

The guide plate 10 may be in metal such as aluminum. The one or more channels may be formed by elongated recessed positions in the guide plate. The one or more channels may be formed by milling.

The guide plate may comprise a plurality of channels 11. The channels may extend parallel to each other along the guide plate 10. Preferably, the guide plate may comprise more than 30 channels and even more preferably over 60 channels.

Advantageously, each of the plurality of channels may be provided with an object measurement unit and at least one ejector unit.

The sorting units 100 may have a capacity of sorting between 500 kg/h and 5000 kg/h of objects. The objects may for example be grains, in such a case the sorting units may have a capacity of between 1500 kg/h and 3000 kg/h.

A sorting system similar to the one described above is known in the State of the Art for the skilled person from previously referenced WO 2019/054932. The sorting system and sorting unit will therefore only be briefly described below.

The at least one ejector unit 14 and the object measurement unit 13 may be operatively connected to the control system. The control system may be configured to control said at least one ejector unit 14 and object measurement unit 13. The control system may be operatively connected to the sorting system control unit 20.

In one embodiment, the object measurement unit 13 is adapted to conduct an optical measurement associated with the at least one property of the object O. In one embodiment, the object measurement unit 13 comprises a light sensor device. The light sensor device may comprise a light transmitter, such as a LED and a light receiving unit such as a photo diode for receiving the light emitted from the light transmitter after the light has hit the object, whereby the at least one property of the object is measured. The light transmitter may be configured to emit a Near Infra-red (NIR) beam onto the object. The light transmitter may be arranged on an opposite side of the channel of the light receiving unit so as to face said light transmitter.

In one embodiment, the optical measurement is performed by means of a camera system. Hence, the object measurement unit 13 may comprise one or more cameras configured to conduct an optical measurement associated with the at least one property of the object O. At least one camera may be arranged to conduct said optical measurement of the objects conveyed through each channel of the sorting unit.

In one embodiment, the optical measurement is conducted via one or more measurement aperture 78 disposed in the channel 11. The one or more measurement aperture 78 is disposed between the first longitudinal position P1 and the second longitudinal position P2. The optical measurement is conducted when the object O passes the measurement aperture 78 towards the second longitudinal position P2.

In one embodiment, each ejector unit 14 of the at least one ejector unit 14 is arranged to eject the object O conveyed in the channel 11 when reaching an ejection position downstream of the first longitudinal position P1 of the channel 11. Each ejector unit 14 may be associated with an individual ejection position, i.e. each ejector unit 14 may be disposed along the channel 11 at a position corresponding to an associated ejection position.

In one embodiment, the at least one ejector unit 14 is a pneumatic ejector unit. The pneumatic ejector unit may be operated by means of the pneumatic system (shown in FIG. 1). Hence, the pneumatic ejector unit is supplied with pressurized air from the pneumatic system in order to provide the pressure for the ejection of the object. The pneumatic ejector unit is configured to release a concentrated pulse of pressurized air in order to eject the object. As aforementioned, the concentrated pulse may be achieved by means of valves controlled by the control system.

Advantageously, the at least one ejector unit 14 is configured to eject the object O based on the at least one measured property of the object O and a timing signal associated with a conveying velocity of the object O being conveyed along the channel 11. Compared to other prior art systems this does not require a camera rig etc. for measuring the property. Instead, this may be performed by determining the velocity of the object. This allows for a much more compact sorting system due to the space requirements on the object measuring unit being lower compared to a camera rig for directly measuring and determining the size and color of the object for example.

In an alternative embodiment, the timing signal may instead be based on the type of object conveyed. Accordingly, the at least one ejector unit 14 may be configured to eject the object O based on the at least one measured property of the object O and a timing signal associated with a predefined object type associated with the object O. Hence, a user may for example input the type of object to be conveyed and sorted by means of a user interface of the system, whereby an appropriate timing signal may be selected automatically.

Referencing FIG. 7, the object measurement unit 13 is provided to conduct an optical measurement associated with at least one property of an object via the one or more measurement aperture 78 when said object passes the measurement aperture 78 towards the second longitudinal position P2. The measurement aperture 78 may optionally be provided with a mesh, grid, or transparent material, such as glass, adapted not to interfere with the optical measurement over the object O, such that the aperture 78 not necessarily is adapted in size to the size of the object, which in turn gives the opportunity to measure in the axial plane over the entire length of the object O. Also, the measurement aperture 78 may be arranged transversally of a multitude of channels 11, and optionally even interrupting the channels 11 over a certain detection gap, i.e. a gap extending across the channel 11. The measurement aperture 78, arranged transversally of a multitude of channels 11, may be combined with a mesh or grid. At least one ejector unit 14 is arranged to eject the object conveyed on the corresponding channel 11 when reaching a corresponding ejection position located downstream of the measurement aperture 78 based on the at least one measured property of the object and a timing signal corresponding to a conveying velocity, i.e. the relevant velocity for the movement of the object O towards its corresponding ejector unit 14, of the object being conveyed along the channel 11. When more than one fraction is to be separated from the bulk of objects, each channel 11 may be provided with more than one ejection position, each ejection position having its corresponding ejector unit 14 to separate a corresponding fraction, based on at least one property of the object O. In one embodiment, measurement may be conducted via a plurality of measurement apertures 78. Hence, a light sensor device may be arranged at every measurement aperture 78. Preferably, the measurement apertures 78 may be provided as separate recesses provided in the channel 11.

Depending on the properties of the object, the object may not be ejected at any ejection position, whereby it is conveyed to the sorting outlet and out of the sorting unit.

In one less preferred embodiment, a separate collecting tray, open channel, vessel or similar may be provided for gathering objects ejected from the channel and guiding plate. However, such an embodiment is not preferred due to the risk for contamination as well as objects missing the intended target.

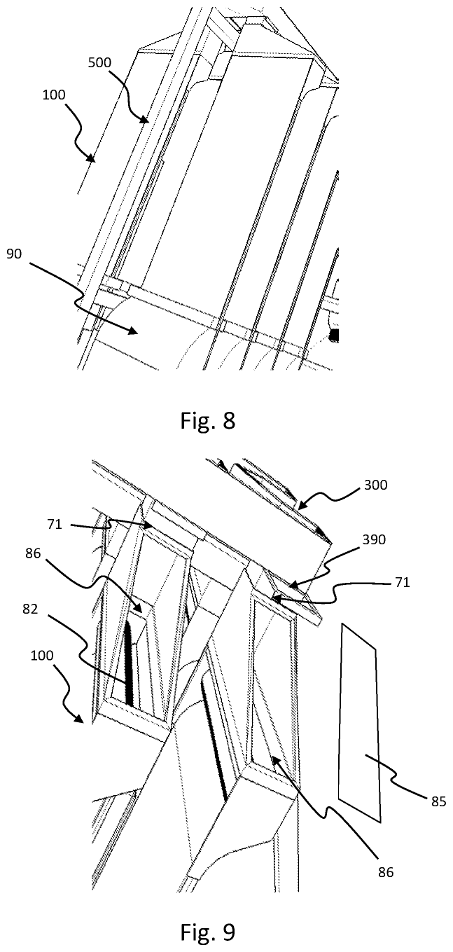

A preferred solution for collecting the ejected object is most clearly depicted in FIG. 8 as well as FIG. 4. According to said preferred solution, the sorting units may be provided with collector channels for gathering and conveying ejected objects. The use of sealed-off collector channels allows for a cleaner process which does not risk dust and debris accumulating in other parts of the system or leaking out into the environment around the system.

Accordingly, the sorting units 100 may comprise one or more collector channel. The one or more collector channel may be arranged to collect an ejected object for conveying said ejected object out of the sorting unit 100. Thus, the one or more collector channel may be arranged to receive said ejected object and convey said ejected object out of the sorting unit 100. The one or more collector channel may be arranged to convey said ejected object by means of gravity.

In one embodiment, the sorting units 100 comprises a collector manifold 90. The sorting units 100 may comprise a plurality of collector channels, whereby the collector manifold 90 comprises said plurality of collector channels.

The plurality of sorting units 100 may be connected to the plurality of inlets of the outlet manifold 400 for conveying the objects to said outlet manifold 400. Thus, the one or more collector channels and/or the sorting outlet may be connected to at least one of the inlets 421, 422, 423 of the outlet manifold 400.

As further depicted, the sorting outlet may be connected to the outlet manifold 400 for conveying the objects out of the sorting unit 100. Thus, the sorting outlet may be connected to one of the inlets 421, 422, 423 of the outlet manifold 400.

In one embodiment, both the objects conveyed by means of the sorting outlet and the collector channels may be conveyed to the outlet manifold. Hence, the sorting outlet and the one or more collector channels of the sorting unit may be connected to different separate outlet passages 411, 412, 413 of the outlet manifold 400.

Thus, the sorting outlet of the sorting unit 100 may be connected to a first inlet 421 of the outlet manifold 400. A collector channel of the sorting unit 100 may be connected to a second inlet 422 of the outlet manifold 400. As depicted in FIG. 4, additional collector channels may be provided, whereby said additional collector channels each may be connected to a corresponding inlet of the outlet manifold 400.

In an alternative embodiment, the objects may be ejected also at the second longitudinal position P2. Thus, one of the collector channels may form the sorting outlet 72. The second longitudinal position P2 may thus form an ejection position.

In one embodiment, a sorting outlet of a first sorting unit 100 and a sorting outlet of a second sorting unit 100 is each connected to the same first separate outlet passage 411 via the inlets of the outlet manifold 400 for conveying sorted objects from the sorting outlet to said first separate outlet passage. Correspondingly, a first collector channel of a first sorting unit 100 and a first collector channel of a second sorting unit 100 may each be connected to the same second separate outlet passage 412 via the inlets of the outlet manifold 400 for conveying sorted objects from the first collector channel to said second separate outlet passage. A second, third, fourth collector channel etc. may be connected in a corresponding manner. Further, a third, fourth, fifth sorting unit etc. may be connected to the same separate outlet passage in a corresponding manner as the first and second sorting unit.

Although not depicted, the system may be provided with a built-in bypass in order to avoid blockage. The built-in bypass may be in the form of a bypass passage directly connecting the inlet manifold and the outlet manifold without conveying the objects through a sorting unit. The bypass passage may connect one or more inlets of the inlet manifold with one or more outlets of the outlet manifold for conveying the objects from the inlet manifold to the outlet manifold. The bypass passage may be selectively closable for example by means of a gate unit. The built-in bypass allows for a fraction of the objects that is not to be sorted to be conveyed directly to the outlet manifold from the inlet manifold, thereby achieving a greater flow of objects throughout the system without requiring additional sorting units.

Preferably, the object distribution and conveying system is a closed-off system, whereby the connections between inlet manifold, outlet manifold and sorting units are sealed connections. In one embodiment, the system may comprise a suction system configured to generate a negative pressure in the direction of the outlet manifold. The suction system may comprise a fan system such as an aspiration system for forcing dust out of the system. In one embodiment, exhausting units may be arranged in the outlet manifold in conjunction with air channels for forcing dust out of the outlet passages.

Referencing FIG. 9, the system may comprise a plurality of feeding rollers 82. Each feeding roller 82 may be arranged at a sorting inlet 71 of a sorting unit 100 of the plurality of sorting units for controlling the distribution of the objects into said sorting unit 100. Hence, the feeding rollers 82 may be configured to control the distribution of the objects into said sorting unit 100. The feeding rollers 82 may be operatively connected to the control system, whereby the control system is configured to control and adjust the speed of said feeding rollers 82. The feeding roller extend across the sorting unit 100, and preferably across width of the sorting inlet 71, i.e. across a cross-section of the sorting inlet 71. The feeding rollers thus enable distribution of objects across the entire width of the sorting inlet 71. The feeding rollers may be provided with guiding members urging movement of the objects upon rotation of the roller. In one embodiment, a feeding roller 82 is provided at each sorting inlet 71.

Preferably, the guiding arrangement is during operation close to entirely filled with objects, whereby the feeding rollers 82 gradually feeds objects into the channels of the sorting units.

In the depicted embodiment, the sorting inlet 71 comprises a buffer zone. The feeding roller 82 may be arranged in the sorting inlet 71 downstream from the buffer zone to distribute the objects into the sorting inlet 71 of the sorting unit 100.

Further referencing FIG. 9, the sorting unit 100 may be provided with inspection means 86 for visual control of the interior of the sorting unit 100. The inspection means 86 may comprise an inspection aperture and a lid 85 for selectively closing off said inspection aperture. It may also be envisioned that the sorting unit is provided with a transparent portion allowing a user to inspect the interior thereof. Preferably, the inspection means 86 may be arranged to selectively enable visual control of the interior of the buffer zone of the sorting unit 100.

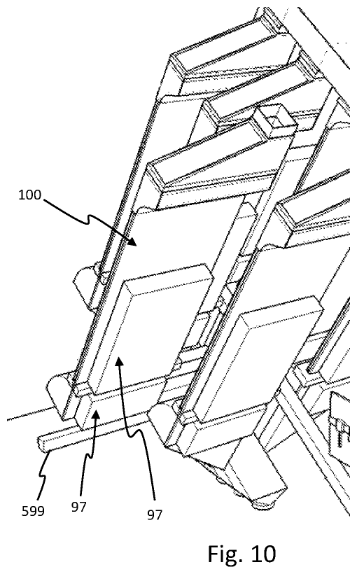

FIG. 10 depicts additional aspects of the system.

For example, in order to allow for easy service and replacement of sorting units 100. The support structure may be adapted to movably receive the sorting units 100. The object and conveying arrangement may thus further comprise an attachment arrangement to releasably fix the sorting units 100 to the support structure. The attachment arrangement may be adapted to selectively allow relative movement between the support structure and one or more of the sorting units 100. In one embodiment, the support structure may comprise rails 599 adapted to accommodate sliding movement of the sorting unit 100 relative the support structure. The rail 599 may be permanently mounted to the support structure or releasably mounted to said support structure.

As further depicted in FIG. 10, the sorting units 100 may comprise an electronics module 97. The electronics module 97 may accommodate the one or more ejector unit and the object measurement unit of the sorting system. The electronics module 97 may further accommodate valves, pneumatic circuits, printed circuit boards etc. operating said ejector unit and object measurement unit of the sorting system. The electronics module 97 may be disposed on, i.e. form a part of, an exterior surface of the sorting unit 100 to allow easy access for an operator. Further, the electronics module 97 may be arranged so as to be accessible upon releasing of the sorting unit 100 from the support structure. In the depicted embodiment, electronics module comprises two separate sub-modules, it may however be envisioned that the electronics module may comprise any number of sub-modules. In one embodiment, the electronics module is disposed within a single housing.

According to an aspect, an object sorting system is provided. The object sorting system may be an object sorting system comprising a plurality of sorting units as described with reference to the FIGS. 1-10.

The object sorting system may comprise a plurality of sorting units 100. The plurality of sorting units 100 comprises a guide plate 10. The guide plate 10 has at least one channel 11. The at least one channel 11 extends in a sorting plane SP inclined relative a horizontal reference plane for conveying the objects O from a first longitudinal position P1 to a second longitudinal position P2 downstream to the first longitudinal position P1. The first longitudinal position P1 is elevated relative the second longitudinal position P2.

The object sorting system further comprises a sorting inlet 71 for conveying the objects O into the sorting unit 100 to the first longitudinal position P1 and a sorting outlet 72 for conveying the objects O out of the sorting unit 100 from the second longitudinal position P2.

The object sorting system further comprises a sorting system comprising an object measurement unit 13 for conducting measurement associated with at least one property of an object O of the objects O and at least one ejector unit 14. The at least one ejector unit 14 is arranged to eject the object O conveyed based on the at least one measured property of the object at a longitudinal position of the channel 11 between the first and second longitudinal position P1, P2.

At least one sorting unit 100 of the plurality of sorting units is arranged above at least one other sorting unit 100 of the plurality of sorting units relative a vertical reference direction.

Each sorting unit of the plurality of sorting units comprises a sorting system. In one embodiment, the angle between each of the sorting planes SP and the vertical reference direction is between 30 and 60 degrees.

In one embodiment, at least two sorting units 100 have channels 11 extending in coinciding sorting planes SP.

In one embodiment, at least two sorting units 100 have channels 11 extending in substantially parallel sorting planes SP.

In one embodiment, at least two sorting units 100 and/or sorting planes SP are arranged in a stacked configuration along a stacking axis SA.

In one embodiment, the object measurement unit 13 is adapted to conduct an optical measurement associated with the at least one property of the object O. The optical measurement may be conducted via one or more measurement aperture 78 disposed in the channel 11 between the first longitudinal position P1 and the second longitudinal position P2 when the object O passes said measurement aperture 78 towards the second longitudinal position P2.

In one embodiment, wherein each ejector unit 14 of the at least one ejector unit 14 is arranged to eject the object O conveyed in the channel 11 when reaching an ejection position downstream of the first longitudinal position P1 of the channel 11.

In one embodiment, the at least one ejector unit 14 is configured to eject the object O based on the at least one measured property of the object O and a timing signal associated with a conveying velocity of the object O being conveyed along the channel 11 or a predefined object type associated with the object O.

In one embodiment, wherein the sorting units 100 comprises one or more collector channel. The one or more collector channel is arranged to collect an ejected object O for conveying said ejected object O out of the sorting unit 100. The sorting units 100 may comprise a collector manifold 90. The collector manifold 90 may comprise a plurality of collector channels for conveying the objects O out of the sorting units 100.

In one embodiment, the sorting plane SP is arranged to extend in an angle relative a horizontal reference plane larger than an angle of repose of the objects O such that the objects O are at least partially conveyed by means of gravity.

According to an aspect, an object distribution and conveying system is provided, the system comprises an object sorting system according to any one of the previously described embodiments and an inlet manifold with one or more feeder inlet for receiving the objects and conveying said objects into the inlet manifold. The inlet manifold further comprises outlets connected to the sorting inlets of the sorting units of the object sorting system.

In one embodiment, the system may comprise an outlet manifold with inlets connected to the sorting outlets of the sorting units of the object sorting system for conveying the objects out of the object distribution and conveying system.

In one embodiment, the system comprises a support structure. The support structure is adapted to carry and support the sorting units. Hence, the support structure is adapted to retain the sorting units. Preferably, the support structure is adapted to releasably retain the sorting units.

1. An object sorting system comprising a plurality of sorting units, wherein said plurality of sorting units comprises:
a guide plate having at least one channel extending in a sorting plane inclined relative a horizontal reference plane for conveying the objects from a first longitudinal position to a second longitudinal position downstream to the first longitudinal position, the first longitudinal position being elevated relative the second longitudinal position,
a sorting inlet for conveying the objects into the sorting unit to the first longitudinal position,
a sorting outlet for conveying the objects out of the sorting unit from the second longitudinal position,
a sorting system comprising an object measurement unit for conducting measurement associated with at least one property of an object of the objects and at least one ejector unit arranged to eject the object conveyed based on the at least one measured property of the object at a longitudinal position of the channel between the first and second longitudinal position,
wherein at least one sorting unit of the plurality of sorting units is arranged above at least one other sorting unit of the plurality of sorting units relative a vertical reference direction.

2. The object sorting system according to claim 1, wherein the angle between each of the sorting planes and the vertical reference direction is from 30 to 60 degrees.

3. The object sorting system according to claim 1, wherein at least two sorting units have channels extending in coinciding sorting planes.

4. The object sorting system according to any one of the preceding claim 1, wherein at least two sorting units have channels extending in substantially parallel sorting planes.

5. The object sorting system according to any one of the preceding claim 1, wherein at least two sorting units and/or sorting planes are arranged in a stacked configuration along a stacking axis.

6. The object sorting system according to claim 1, wherein the object measurement unit is adapted to conduct an optical measurement associated with the at least one property of the object.

7. (canceled)

8. (canceled)

9. (canceled)

10. (canceled)

11. (canceled)

12. (canceled)

13. (canceled)

14. An object distribution and conveying arrangement for distributing and conveying a plurality of objects, said arrangement comprising an outlet manifold for receiving and conveying sorted objects from at least two sorting units,
wherein the outlet manifold comprises a plurality of inlets for conveying the sorted objects out of the sorting units and at least two separate outlet passages,
wherein each of the at least two separate outlet passages is joined with at least two inlets of the plurality of inlets, each of said at least two inlets being arranged to convey sorted objects from a respective sorting unit of the at least two sorting units into said separate outlet passage.

15. The object distribution and conveying arrangement according to claim 14, wherein the outlet manifold is adapted to be releasably connected to the sorting units.

16. The object distribution and conveying arrangement according to claim 14, wherein the each separate outlet passage is connected to a distribution outlet for conveying the objects out of the object distribution and conveying arrangement.

17. The object distribution and conveying arrangement according to claim 14, wherein the outlet manifold is adapted to convey the objects downwardly and diagonally relative a horizontal reference plane from the plurality of inlets downstream through the at least two separate outlet passages.

18. (canceled)

19. (canceled)

20. (canceled)

21. The object distribution and conveying arrangement according to claim 14, wherein the plurality of inlets form inlet channels, said inlet channels being adapted to convey the objects downwardly and diagonally relative a horizontal reference plane.

22. (canceled)

23. The object distribution and conveying arrangement according to claim 14, further comprising an inlet manifold) for receiving and conveying the objects to the sorting units for sorting of the objects, wherein the inlet manifold comprises one or more feeder inlet for feeding the objects into the inlet manifold and at least two outlets for distributing the objects to the sorting units.

24. (canceled)

25. (canceled)

26. (canceled)

27. (canceled)

28. (canceled)

29. (canceled)

30. (canceled)

31. (canceled)

32. (canceled)

33. The object distribution and conveying arrangement according to claim 14, wherein the inlet manifold is adapted to be releasably connected to the sorting units.

34. The object distribution and conveying arrangement according to claim 14, further comprising a support structure, said support structure being adapted to releasably retain the sorting units.

35. (canceled)

36. The object distribution and conveying arrangement according to claim 14, further comprising gate units provided at the inlet manifold, each gate unit being adapted to selectively enable conveying and distribution of the objects to a sorting unit.

37.-56. (canceled)

57. An object distribution and conveying arrangement for distributing and conveying a plurality of objects, said arrangement comprising:
an inlet manifold for receiving and conveying the objects to sorting units for sorting of the objects,
wherein the inlet manifold comprises:
one or more feeder inlet for feeding the objects into the inlet manifold, at least two outlets for distributing the objects to the sorting units, and a guiding arrangement connecting the one or more feeder inlet and the at least two outlets, said guiding arrangement being adapted to convey the objects downwardly and diagonally relative a horizontal reference plane from the one or more feeder inlet downstream to the at least two outlets.

58. The object distribution and conveying arrangement according to claim 57, wherein the guiding arrangement is arranged to convey the objects in an angle relative a horizontal reference plane larger than an angle of repose of the objects such that the objects are at least partially conveyed by means of gravity.

59. The object distribution and conveying arrangement according to claim 57, wherein the guiding arrangement forms a plurality of passages for conveying and distributing the objects to the at least two outlets.

60. (canceled)

61. The object distribution and conveying arrangement according to claim 57, wherein the guiding arrangement is arranged to convey the objects along a feeding plane, said feeding plane being inclined relative a reference horizontal plane.

62. (canceled)

63. (canceled)

64. (canceled)

65. (canceled)

66. The object distribution and conveying arrangement according to claim 57, wherein the inlet manifold is adapted to be releasably connected to the sorting units.

67.-93. (canceled)
